(19) United States
(12) Patent Application Publication
(10) Pub. No.: US 2026/0035638 A1
(43) Pub. Date: Feb. 5, 2026

(54) NON-AQUEOUS GEL

(71) Applicant: Reckitt Benckiser Finish B.V., Hoofddorp (NL)

(72) Inventors: Alias Younis Al-Bayati, Heidelberg (DE); Torsten ROTH, Heidelberg (DE); Alexander WINK, Heidelberg (DE)

(21) Appl. No.: 18/872,543

(22) PCT Filed: Jun. 12, 2023
(86) PCT No.: PCT/EP2023/065636

§ 371 Date: Dec. 6, 2024

(30) Foreign Application Priority Data
Jun. 15, 2022 (GB) 2208819.9

(51) Int. Cl. C11D 3/39; A47L 15/44; C11D 17/00; C11D 17/04

(52) U.S. Cl. CPC C11D 3/3942; A47L 15/4436; A47L 15/4472; A47L 15/449; C11D 17/0039; C11D 17/045

(57) ABSTRACT

The present invention is related to a non-aqueous gel comprising at least one bleaching agent, wherein said at least one bleaching agent comprises coated granules of sodium percarbonate; wherein said non-aqueous gel comprises at least one builder compound, such as a citrate; and wherein the non-aqueous gel is substantially free, preferably completely free, of water.

### FIELD OF THE INVENTION

The present invention relates to a non-aqueous gel comprising at least one bleaching agent.

The present invention is also directed to a dishwashing, preferably an automatic dishwashing, water-soluble container and an autodosing automatic dishwashing system.

### BACKGROUND OF THE INVENTION

Automatic dishwashing detergent gel compositions with a pleasing aesthetic profile, i.e., having a smooth, continuous visual appearance, are significantly more appealing to consumers than compositions purely in a granular, powder or tablet form. Gel compositions are often used in a multi-compartment product, in which the gel composition is present in one compartment, and one or more powders, tablets or granules are present in one or more further compartments. Detergent gel compositions in the form of a gel often comprise a thickening agent to attempt to provide a detergent gel composition which a consumer will find aesthetically pleasing and which includes desired dissolution and ingredient release properties. A suitable thickening agent should provide a favourable stability profile, such that the detergent gel composition exhibits good phase-stability during storage, primarily by having a high temperature of phase separation. The phase separation of a previously homogenous gel upon aging or storage at room temperature may convey to the consumer that the detergent gel composition has declined in activity, decomposed or is a poor-quality product. Maintaining the visual appearance of a detergent gel composition is, therefore, of significant importance.

Detergents for home care cleaning (laundry and dish care, laundry additives, products for hard surface cleaning, etc.) have included bleaching agents as an active component for over a hundred years.

However, oxidating agents such as perborate and lately percarbonate remain challenging to formulate due to their inherent reactivity and incompatibility with other common detergent ingredients (e.g., dyes, enzymes).

A recent review article, namely “Bleaching systems in domestic laundry detergents: a review; G. O. Bianchetti, C. L. Devlin, K. R. Seddon, RSC Adv. 2015, 5, 65365-65384” states:

“Hydrogen peroxide is kinetically stable in the absence of catalysts or other accelerating factors (e.g., light, heat), and strict storage conditions (typically involving radical scavengers, the minimisation of transition metal ion sources, and an acidic pH) can minimise decomposition. However, even low levels of decomposition generate oxygen, which can pressurise sealed equipment and create ‘oxygen enrichment’ in the headspace of the container. [. . . ] Solid sources of hydrogen peroxide proved more suitable for inclusion in detergent products . . . ”

The majority of current automatic dishwashing detergents employ therefore granular bleaching agents in the solid powder phase.

Although gels comprising bleaching agents for automatic dishwashing processes are generally known, these are usually employing chlorine-based bleaching agents and are consequently free from enzymes, whereby a generally inferior wash performance is achieved.

### OBJECTIVE OF THE PRESENT INVENTION

In view of the prior art, it was thus an object of the present invention to provide a non-aqueous gel, which shall comprise a bleaching agent, which is not exhibiting the aforementioned shortcomings of the known chlorine-based gels.

Additionally, it was especially an object of the present invention to provide a non-aqueous gel, which shall comprise a bleaching agent, which is suitable for an application as monodose detergent product as well as for an application as a detergent gel for autodosing automatic dishwashing processes.

In particular, it was an object of the present invention to provide a non-aqueous gel which shall be able to maintain the level of active oxygen throughout storage, ideally at neutral or alkaline conditions while at the same time compatibility with other ingredients shall be ensured.

### SUMMARY OF THE INVENTION

These objects and also further objects which are not stated explicitly but are immediately derivable or discernible from the connections discussed herein by way of introduction are achieved by a non-aqueous gel having all features of claim 1. Appropriate modifications to the inventive non-aqueous gel are protected in dependent claims 2 to 9. Further, claim 10 relates to a dishwashing, preferably an automatic dishwashing, water-soluble container, while claims 11 and 12 are appropriate modifications thereof. Claim 13 relates to an autodosing automatic dishwashing system, while claims 14 and 15 are appropriate modifications thereof.

The present invention accordingly provides a non-aqueous gel comprising at least one bleaching agent, characterized in that said at least one bleaching agent comprises coated granules of sodium percarbonate; wherein said non-aqueous gel comprises at least one builder compound, such as a citrate; and wherein the non-aqueous gel is substantially free, preferably completely free, of water.

It is thus possible in an unforeseeable manner to provide a non-aqueous gel comprising a bleaching agent, which does not exhibit the aforementioned shortcomings of the known chlorine-based gels.

Additionally, a non-aqueous gel is offered, which comprises a bleaching agent, wherein said non-aqueous gel is suitable for an application as monodose detergent product as well as for an application as a detergent gel for autodosing automatic dishwashing processes.

In addition, the inventive non-aqueous gel maintains the level of active oxygen throughout storage, even at neutral or alkaline conditions while at the same time compatibility with other ingredients is ensured. This provides the additional advantage of being able to combine a bleaching agent with an enzyme in the gel without significant undesired interactions among them.

### BRIEF DESCRIPTION OF THE TABLES

Objects, features, and advantages of the present invention will also become apparent upon reading the following description in conjunction with the tables, in which:

Table 1 exhibits a comparison of formulations comprising sodium percarbonate in either a solid powder compartment (comparative example) or in a gel compartment (inventive example).

Table 2 exhibits a comparison of the gel compartment of the comparative formulation versus the respective gel compartment of two different inventive formulations.

Table 3 exhibits experimental results for storage stability of the inventive gel.

Table 4 exhibits a visual rating of the storage experiments of Table 3.

Table 5 exhibits the cleaning performance test conditions for the experiments shown in Table 6.

Table 6 exhibits cleaning performance test experiments.

### DETAILED DESCRIPTION OF THE INVENTION

Gels are generally defined as a non-fluid colloidal network or polymer network that is expanded throughout its whole volume by a fluid, with hydrogels having water as the expanding or swelling agent. Herein, the term gel is not limited to a strictly colloidal composition and for the purposes of the present invention the term gel may be also considered to be a thickened liquid. The term ‘gel-like’ may refer to a combination of liquid and solid, or a suspension of solid-in-liquid, that has the appearance and/or consistency of a gel.

In a preferred embodiment, the inventive gel has a viscosity higher than a classical liquid or pure aqueous solution, preferably higher than 2500 cP at 25° C. at 0.1 s⁻¹ and higher than 1000 cP at 25° C. at 300s⁻¹.

The viscosity has been measured by a research rheometer (DHR10, TA Instruments) fitted with a Brookfield V73 vane in a small concentric cylinder system, vane diameter 12.67 mm, vane length 25.3 mm, and cylinder diameter 15.43 mm.

The expression “substantially free” means in the context of the present invention a concentration of less than 5 wt %, preferably less than 3 wt %, and more preferably less than 0.5 wt %.

By the term “water-soluble container” as used herein, it is meant a container which at least partially dissolves in water or disperses in water at 20° C. within 10 minutes to allow for egress of the contents of the package into the surrounding water.

By “monodose”, it is meant that the product comprises one or more compositions in the quantity required for a single wash cycle of a machine dishwasher.

The thermoformed water-soluble film comprising poly (vinyl alcohol) may be rigid or flexible at room temperature.

Preferably, the poly (vinyl alcohol) film may be partially or fully alcoholised or hydrolysed, for example, it may be from 40 to 100%, preferably 70 to 92%, most preferably about 85% to about 92%, alcoholised or hydrolysed, polyvinyl acetate film. The degree of hydrolysis is known to influence the temperature at which the PVOH starts to dissolve in water. 88% hydrolysis corresponds to a film soluble in cold (i.e. room temperature of 20° C.) water, whereas 92% hydrolysis corresponds to a film soluble in warm water. The film may be cast, blown or extruded. It may further be unoriented, mono-axially oriented or bi-axially oriented.

In one embodiment, said non-aqueous gel comprises at least a bleaching activator, such as tetraacetylethylenediamine (TAED); and/or a bleach catalyst, for example a manganese complex comprising 1,4,7-triazacyclononane (TACN), or any derivatives of a TACN ligand, for example 1,4,7-trimethyl-TACN, or manganese oxalate, manganese acetate or a dinuclear manganese complex, for example a dinuclear manganese complex comprising TACN or any derivatives of a TACN ligand, for example 1,4,7-trimethyl-TACN.

In one embodiment, said non-aqueous gel does not additionally comprise any other bleaching agents besides the coated granules of sodium percarbonate.

In one embodiment, said non-aqueous gel is substantially free, preferably completely free, of enzymes, such as protease and amylase; and substantially free, preferably completely free, of bleach activators, such as TAED.

In one embodiment, said non-aqueous gel comprises 5 to 40 wt %, preferably 10 to 30 wt %, and more preferably 15 to 25 wt % of the at least one builder compound, such as a citrate.

In a preferred embodiment thereof, the at least one builder compound is selected from the group consisting of hydroxycarboxylates (such as a citrate salt, for example trisodium citrate, which may be anhydrous), aminocarboxylates (such as methyl glycine diacetic acid (MGDA), or N,N-dicarboxymethyl glutamic acid (GLDA), dicarboxylic acid amines (such as iminodisuccinic acid (IDS)) and/or phosphates (such as tripolyphosphate), or the salts thereof.

The inventive gel may comprise a secondary builder (co-builder), for example a phosphonate or a polymer.

The inventive gel may comprise at least one polymer, preferably at least one polycarboxylate. By the term ‘polycarboxylate’, we mean any polymeric species comprising a carboxylic acid or carboxylate groups available for chelation. The polycarboxylate polymer may be a homopolymer and/or a copolymer and/or a terpolymer.

The polymer may be a polycarboxylate polymer comprising an acrylic acid homopolymer. The homopolymer may have a molecular weight of between about 2,000 and about 10,000, between about 3,000 and about 9,000, or between about 4,000 and about 8,000.

The at least one polycarboxylate may comprise a sulphonic acid monomer. The sulphonic acid monomer may be present in an amount of from about 4 to about 14 wt %, from about 5 to about 13 wt %, from about 6 to about 12 wt % or from about 7 to about 11 wt % based on the total weight of the at least one poly-carboxylate.

Preferred monomers containing sulphonic acid groups are those of the formula:

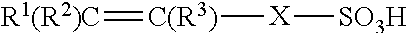

in which R¹ to R³ mutually independently denote —CH₃, a straight-chain or branched saturated alkyl residue with 2 to 12 carbon atoms, a straight-chain or branched, mono-or polyunsaturated alkenyl residue with 2 to 12 carbon atoms, alkyl or alkenyl residues substituted with —NH₂, —OH or —COOH, or denote —COOH or —COOR₄, R⁴ being a saturated or unsaturated, straight-chain or branched hydrocarbon residue with 1 to 12 carbon atoms, and X denotes an optionally present spacer group which is selected from —(CH₂)n- with n=0 to 4, —COO—(CH₂) k- with k=1 to 6, —C(O)—NH—C(CH₃)₂- and CH(CH₂CH₃)-.

Preferred monomers of the above formula include, for example, those of the formulae:

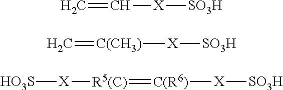

in which R⁵ and R⁶ are mutually independently selected from —H, —CH₃, —CH₂CH₃, —CH₂CH₂CH₃, —CH(CH₃)₂ and X denotes an optionally present spacer group which is selected from —(CH₂)n- with n=0 to 4, —COO—(CH₂)k with k=1 to 6, —C(O)—NH—C(CH₃)₂- and —C(O)—NH—CH(CH₂CH₃)-.

Preferred monomers containing sulphonic acid groups are here 1-acrylamido-1-propanesulphonic acid, 2-acrylamido-2-propanesulphonic acid, 2-acrylamido-2-methyl-1-propanesulphonic acid, 2-methacrylamido-2-methyl-1-propanesulphonic acid, 3-methacrylamido-2-hydroxypropane-sulphonic acid, allylsulphonic acid, methallylsulphonic acid, allyloxybenzenesulphonic acid, methallyloxybenzenesulphonic acid, 2-hydroxy-3-(2-propenyloxy) propanesulphonic acid, 2-methyl-2-propene-1-sulphonic acid, styrenesulphonic acid, vinylsulphonic acid, 3-sulphopropyl acrylate, 3-sulfopropyl methacrylate, sulphomethacrylamide, sulphomethylmethacrylamide and mixtures of the stated acids or the water-soluble salts thereof. Particularly preferred is 2-acrylamido-2-methyl-1-propane-sulphonic acid.

The sulphonic acid groups may be present in the polymers entirely or in part in neutralized form, i.e. the acidic hydrogen atom of the sulphonic acid group may be replaced in some or all of the sulphonic acid groups with metal ions, preferably alkali metal ions and in particular with sodium ions. It is preferred according to the invention to use copolymers containing partially or completely neutralized sulphonic acid groups.

The polymer may comprise polyepoxysuccinic acid (PESA) or derivatives thereof. Polyepoxysuccinic acid is also known as epoxysuccinic acid homopolymer, polyoxirane-2,3-dicarboxylic acid, 2,3-oxiranedicarboxylic acid homopolymer, or poly (1-oxacyclopropane-2,3-dicarboxylic acid); and has the general structure:

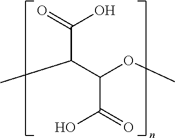

and where the derivatives thereof have the general structure:

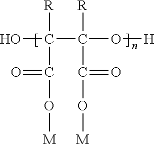

where R may be hydrogen or any organic chain (but preferably an ester such as C₁₋₄ alkyl) and where M may be any cation (preferably Nat, H⁺, K⁺, and/or NH₄⁺).

All references to PESA hereafter are to be taken to refer to polyepoxy-succinic acid or derivatives thereof, unless otherwise stated.

The PESA may have a molecular weight (Mw) of from about 100 to about 10,000 g mol⁻¹, from about 400 to about 2000 g mol⁻¹, from about 1000 to about 1800 g mol⁻¹. The PESA may have from about 2 to about 100 repeating monomer units, such as from about 2 to about 50, about 2 to about 45, about 2 to about 20 or from about 2 to about 10 repeating monomer units.

The inventive gel may comprise silver and/or copper corrosion inhibitors as anti-corrosion agents. Preferred silver/copper corrosion inhibitors are benzotriazole (BTA) or bis-benzotriazole and substituted derivatives thereof. Other suitable inhibitors are organic, preferably nitrogen-containing heterocycles; and/or inorganic redox-active substances and paraffin oil. Benzotriazole derivatives are those compounds in which the available substitution sites on the aromatic ring are partially or completely substituted. Suitable substituents are linear or branch-chain C1-20 alkyl groups and hydroxyl, thio, phenyl or halogen such as fluorine, chlorine, bromine, and iodine. A preferred substituted benzotriazole is tolyltriazole.

In one embodiment, said non-aqueous gel comprises at least two different non-ionic surfactants; wherein the total amount of all non-ionic surfactants ranges from 6 to 60 wt %, preferably from 25 to 50 wt %, and more preferably from 35 to 45 wt %.

The non-ionic surfactant may be an optionally end capped alkyl alkoxylate. A preferred class of non-ionic surfactants are ethoxylated non-ionic surfactants prepared by the reaction of a monohydroxy alkanol or alkyl phenol with 6 to 20 carbon atoms. Particularly preferred non-ionic surfactants are the non-ionics from a linear chain fatty alcohol with 10-20 carbon atoms and at least 5 moles of ethylene oxide per mole of alcohol. The non-ionic surfactant may comprise propylene oxide (PO) units in the molecule. The PO units may constitute up to 40 wt %, 35 wt %, 30 wt %, 25 wt %, 20 wt % or up to 15 wt % of the overall molecular weight of the non-ionic surfactant.

In one embodiment, the total amount of said coated granules of sodium percarbonate ranges from 5 to 40 wt %, preferably from 10 to 30 wt %, and more preferably from 15 to 25 wt %.

In one embodiment, the solid content of the inventive gel ranges from 5 to 65 wt %, preferably from 10 to 55 wt %, and more preferably from 15 to 45 wt %.

The solid content comprises at least the builders (synonym to building agents and to builder compound) and the co-builders (synonym to co-building agents and to co-builder compound).

In one embodiment, said coated granules of sodium percarbonate have an active oxygen content ranging from 5 to 25 wt %, preferably from 11 to 18 wt %, and more preferably from 12 to 15 wt %.

In one embodiment, at least 90%, preferably at least 96%, and more preferably at least 98% of said coated granules of sodium percarbonate have a particle size ranging from 150 to 1600 micrometers.

In one embodiment, at least 86%, preferably at least 88%, and more preferably at least 94% of said coated granules of sodium percarbonate have a particle size ranging from 150 to 1400 micrometers.

In one embodiment, the sodium percarbonate content of the coated granules of sodium percarbonate ranges from 80 to 95 wt %, preferably from 82 to 91 wt %, and more preferably from 84 to 88 wt %.

In one embodiment, said non-aqueous gel further comprises at least two non-ionic surfactants; wherein the amount of all non-ionic surfactants ranges from 8 to 40 wt %, preferably from 10 to 30 wt %, and more preferably from 15 to 25 wt % based on the total composition of all powder and gel compartments.

In another embodiment, said non-aqueous gel further comprises at least two non-ionic surfactants; wherein the amount of all non-ionic surfactants in all gel compartments ranges from 8 to 40 wt %, preferably from 10 to 30 wt %, and more preferably from 15 to 25 wt % based on the total composition of all powder and gel compartments.

In another embodiment, said non-aqueous gel further comprises at least two non-ionic surfactants; wherein the amount of all non-ionic surfactants in all powder compartments ranges from 8 to 40 wt %, preferably from 10 to 30 wt %, and more preferably from 15 to 25 wt % based on the total composition of all powder and gel compartments.

These non-ionic surfactants can be in a preferred embodiment alkylpoly-ethylene glycol ethers made from a linear, saturated fatty alcohol.

A typical thickening agent used in conventional dishwashing detergent gel compositions is a polyalkylene glycol, for example a polyalkylene glycol with an ethylene oxide to propylene oxide ratio of 4:1. Polyalkylene glycols of this type are expensive to manufacture and provide little contribution to the cleaning performance profile (including the release profile) and shine performance profile of the detergent gel composition. Conventional detergent gel compositions comprising a polyalkylene glycol can exhibit phase separation at room temperature.

Further, the object of the present invention is also solved by a dishwashing, preferably an automatic dishwashing, water-soluble container characterized in that said water-soluble container is made of a thermoformed water-soluble film comprising poly (vinyl alcohol); wherein said water-soluble container comprises at least a first compartment and at least a second compartment; wherein said at least first compartment is separated from said at least second compartment; wherein said at least first compartment is at least partially filled with a non-aqueous gel according to one of the preceding claims; and wherein said at least second compartment is at least partially filled with a dishwashing powder, wherein said dishwashing powder comprises at least one bleaching agent and at least one builder compound, such as a citrate; and wherein said at least one bleaching agent of the dishwashing powder preferably comprises coated granules of sodium percarbonate.

It has been surprisingly found that the inventive gel in the first compartment of the water-soluble container is stable against build-up of pressure, which normally arises in such a closed compartment due to decomposition of the bleaching agent. The improved storage stability of the inventive gel in the first compartment leads to a non-requirement of such venting holes. Thus, the water-soluble container does not comprise any microperforations in a preferred embodiment of the present invention.

In a preferred embodiment thereof, the total amount of the least one builder compound in all compartments, which are at least partially filled with such an inventive non-aqueous gel, ranges from 2.5 to 35 wt %, preferably from 3.5 to 20 wt %, and more preferably from 5 to 10 wt % based on the total amount of the non-aqueous gel and the dishwashing powder of all compartments;

and wherein the total amount of the least one builder compound in all compartments, which are at least partially filled with a dishwashing powder, ranges from 2.5 to 35 wt %, preferably from 3.5 to 20 wt %, and more preferably from 5 to 10 wt % based on the total amount of the non-aqueous gel and the dishwashing powder of all compartments.

In another preferred embodiment thereof, the total amount of the coated granules of sodium percarbonate in all compartments, which are at least partially filled with such an inventive non-aqueous gel, ranges from 0.1 to 20 wt %, preferably from 2.5 to 17.5 wt %, and more preferably from 5 to 15 wt % based on the total amount of the non-aqueous gel and the dishwashing powder of all compartments;

and wherein preferably the total amount of the coated granules of sodium percarbonate in all compartments, which are at least partially filled with a dishwashing powder, ranges from 0.1 to 20 wt %, preferably from 2.5 to 17.5 wt %, and more preferably from 5 to 15 wt % based on the total amount of the non-aqueous gel and the dishwashing powder of all compartments.

Additionally, the object of the present invention is also solved by an auto-dosing automatic dishwashing system wherein said autodosing automatic dishwashing system comprises at least a first cartridge and at least a second cartridge arranged separated from each other inside of a dishwashing apparatus, wherein said at least first cartridge is at least partially filled with such an inventive non-aqueousgel; and wherein said second cartridge is at least partially filled with a dishwashing powder, which is comprising at least one bleaching agent and at least one builder compound, such as a citrate; and wherein said at least one bleaching agent of the dishwashing powder preferably comprises coated granules of sodium percarbonate;

or alternatively wherein said autodosing automatic dishwashing system comprises a cartridge comprising at least a first cartridge compartment and at least a second cartridge compartment separated from each other inside of said cartridge, wherein said first cartridge compartment is at least partially filled with such an inventive non-aqueous gel; and wherein said second cartridge compartment is at least partially filled with a dishwashing powder, which is comprising at least one bleaching agent and at least one builder compound, such as a citrate; and wherein said at least one bleaching agent of the dishwashing powder preferably comprises coated granules of sodium percarbonate.

In a preferred embodiment thereof, the total amount of the least one builder compound in all cartridges or cartridge compartments, which are at least partially filled with such an inventive non-aqueous gel, ranges from 2.5 to 35 wt %, preferably from 3.5 to 20 wt %, and more preferably from 5 to 10 wt % based on the total amount of the non-aqueous gel and the dishwashing powder of all cartridges or cartridge compartments;

and wherein the total amount of the least one builder compound in all cartridges or cartridge compartments, which are at least partially filled with a dishwashing powder, ranges from 2.5 to 35 wt %, preferably from 3.5 to 20 wt %, and more preferably from 5 to 10 wt % based on the total amount of the non-aqueous gel and the dishwashing powder of all cartridges or cartridge compartments.

In another preferred embodiment thereof, the total amount of the coated granules of sodium percarbonate in all cartridges or cartridge compartments, which are at least partially filled with such an inventive non-aqueous gel, ranges from 0.1 to 20 wt %, preferably from 2.5 to 17.5 wt %, and more preferably from 5 to 15 wt % based on the total amount of the non-aqueous gel and the dishwashing powder of all cartridges or cartridge compartments;

and wherein preferably the total amount of the coated granules of sodium percarbonate in all cartridges or cartridge compartments, which are at least partially filled with a dishwashing powder, ranges from 0.1 to 20 wt %, preferably from 2.5 to 17.5 wt %, and more preferably from 5 to 15 wt % based on the total amount of the non-aqueous gel and the dishwashing powder of all cartridges or cartridge compartments.

The following non-limiting examples are provided to illustrate an embodiment of the present invention and to facilitate understanding of the invention but are not intended to limit the scope of the invention, which is defined by the claims appended hereto.

Herein, an automatic dishwashing water-soluble container made of a thermoformed water-soluble film comprising poly (vinyl alcohol) has been used. Said water-soluble container comprises a first compartment and at least a second compartment; wherein said first compartment is separated from said second compartment; wherein said first compartment is filled with such an inventive non-aqueous gel (two inventive examples) or a comparative gel (comparative example). Said second compartment is filled with a dishwashing powder, wherein said dishwashing powder comprises at least one bleaching agent and at least one builder compound; wherein said at least one bleaching agent of the dishwashing powder comprises coated granules of sodium percarbonate for the comparative example while the two inventive examples do not comprise coated granules of sodium percarbonate in their respective second compartment (powder). Said water-soluble container further comprises a third compartment filled with an identical liquid for all examples (the comparative and the two inventive examples). That is also the reason why the weight percentages given in Table 1 for the comparative example as well as for the two inventive examples do not sum up to 100% in total.

Turning now to the Tables, Table 1 shows a comparison of one comparative formulation comprising coated granules of sodium percarbonate in the second compartment (powder) versus two different inventive formulations comprising coated granules of sodium percarbonate in the first compartment (gel) in accordance with embodiments of the present invention. Herein, the weight percentages given for each individual component is the respective total amount of the respective individual component in the first and second compartment in total.

Table 2 shows a comparison of the respective first compartment (gel) of the comparative formulation versus the respective first compartment (gel) of the two different inventive formulations in accordance with embodiments of the present invention. Herein, the weight percentages given for each individual component is the respective total amount of the respective individual component in the first compartment in total.

TABLE 1
Comparison of formulations comprising sodium percarbonate in either a solid powder
compartment (comparative example) or in a gel compartment (inventive example).

| | | Comparative | Inventive | Inventive |
|---|---|---|---|---|
| | | Formulation | Formulation 1 | Formulation 2 |
| | Raw Materials | [%] | [%] | [%] |
| Builders | Trisodium citrate | — | 8.5 | 8.5 |
| | (powder) | | | |
| | Trisodium citrate (gel) | 15.8 | 7.1 | 7.1 |
| Surfactants, | First non-ionic | 15.3 | 15.3 | 15.3 |
| Thickening | surfactant | | | |
| agents | Polyglycol thickening | 3.7 | — | — |
| | agent | | | |
| | Second non-ionic | — | 3.7 | — |
| | surfactant | | | |
| | Third non-ionic | — | — | 3.7 |
| | surfactant | | | |
| Bleach System | Coated granules of | 13.8 | — | — |
| | sodium percarbonate | | | |
| | (powder) | | | |
| | Coated granules of | — | 14.0 | 14.0 |
| | sodium percarbonate | | | |
| | (gel) | | | |
| | TAED (powder) | — | 5.5 | 5.5 |
| | TAED (gel) | 5.3 | — | — |
| | Cogranulate of TAED | 1.1 | 1.1 | 1.1 |
| | and bleach catalyst | | | |
| Alkalinity | Sodium carbonate | 20.8 | 20.8 | 20.8 |
| | Sodium bicarbonate | 2.4 | 2.2 | 2.2 |
| Co-Builders | Phosphonate | 6.4 | 6.4 | 6.4 |
| | Polycarboxylate | 0.9 | 0.9 | 0.9 |
| | First copolymer | 5.0 | 5.0 | 5.0 |
| | Second copolymer | 0.7 | 0.7 | 0.7 |
| Enzymes | Protease and Amylase | 3.9 | 3.9 | 3.9 |
| Others (fragrances, | Fragrance | 0.3 | 0.3 | 0.3 |
| colorants, | Colorants | 0.04 | 0.04 | 0.04 |
| material | Silver protection agent | 0.2 | 0.2 | 0.2 |
| care agents, | Glass protection agent | 0.1 | 0.1 | 0.1 |
| processing | Antifoaming agent | 0.1 | 0.1 | 0.1 |
| aids, etc.) | | | | |

TABLE 2
Comparison of the gel compartment of the comparative formulation versus
the respective gel compartment of two different inventive formulations.

| | | Comparative | Inventive | Inventive |
|---|---|---|---|---|
| | | Formulation | Formulation 1 | Formulation 2 |
| | Raw Materials | [%] | [%] | [%] |
| Builders | Trisodium Citrate | 42.900 | 19.300 | 19.300 |
| Bleach system | Coated granules of | | 38.000 | 38.000 |
| | sodium percarbonate | | | |
| | TAED | 14.400 | | |
| Surfactants & | First non-ionic | 32.000 | 32.000 | 32.000 |
| Thickeners | surfactant | | | |
| | Polyglycol thickening | 10.000 | | |
| | agent | | | |
| | Second non-ionic | | 10.000 | |
| | surfactant | | | |
| | Third non-ionic | | | 10.000 |
| | surfactant | | | |
| Auxiliaries | First auxiliary agent | 0.700 | 0.700 | 0.700 |

All gels have been prepared by standard routine work by mixing all components together at elevated temperatures until a homogeneous mixture was reached. Afterwards, the storing stability of these gel compartments has been tested for their respective residual active oxygen level. The results are given in the following Table 3.

TABLE 3
Residual active oxygen after storage.

| | | 3 weeks | | | 6 weeks | | |
|---|---|---|---|---|---|---|---|
| | Start | 5° C./50% | 25° C./50% | 40° C./75% | 5° C./50% | 25° C./50% | 40° C./75% |
| Inventive | 5.1 | 5.5 | 5.8 | 4.9 | 5.0 | 5.4 | 4.3 |
| Formulation 1 | (100%) | (100%) | (100%) | (96%) | (98%) | (100%) | (84%) |
| Inventive | 5.1 | 5.0 | 5.5 | 5.4 | 5.2 | 5.3 | 4.8 |
| Formulation 2 | (100%) | (98%) | (100%) | (100%) | (100%) | (100%) | (94%) |

Herein, a residual level of active oxygen greater than 70% after 6 weeks storage at 40° C./75% was considered successful. All experiments for 3 weeks and 6 weeks have been individual samples. All resulting values have been given herein by making use of an upper limit of 100% for the case of unchanged residual oxygen.

In addition, a visual assessment of the gel compartment was conducted, and the rating was compared to a commercial Finish detergent formulation as further comparative example (Table 4).

TABLE 4
Visual rating after storage: “5 - samples unchanged”, to “1 - unacceptable”.

| | | 3 weeks | | | 6 weeks | | |
|---|---|---|---|---|---|---|---|
| | Start | 5° C./50% | 25° C./50% | 40° C./75% | 5° C./50% | 25° C./50% | 40° C./75% |
| Comparative | 5 | 5 | 5 | 4 | 5 | 5 | 4 |
| Formulation | | | | | | | |
| Inventive | 5 | 5 | 5 | 4 | 5 | 5 | 4 |
| Formulation 1 | | | | | | | |
| Inventive | 5 | 5 | 5 | 4 | 5 | 5 | 4 |
| Formulation 2 | | | | | | | |

Herein, the two inventive formulations comprising the coated granules of sodium percarbonate in the gel compartment did not reveal a deteriorated aesthetic performance after storage compared to the comparative formulation, which contains coated granules of sodium percarbonate solely in the powder compartment. Notably, all water-soluble containers remained intact throughout the storage. The visual assessment provides an average score over several metrics such as compartment swelling, pouch sogginess, etc. The colorants comprised in the gel compartments have been at least partially degraded. However, the change in the visual appearance caused by this degradation has not been considered for the visual rating given in Table 4.

Next, the cleaning performance of the inventive gel compartments was assessed versus the comparative gel compartment as shown in the following tables 5 and 6.

TABLE 5
Cleaning Performance test conditions
Parameters

| Machine Type | Bosch |
|---|---|
| Program | 1 h 65° C. |
| Water hardness | 21° GH/375 ppm |
| No. Tests | 2 |

TABLE 6
Cleaning Performance test experiments

| | Comparative | Inventive | Inventive |
|---|---|---|---|
| Type of Stain | Formulation | Formulation 1 | Formulation 2 |
| Bleachable | | | |
| Tea | 7.6 | 7.8 | 7.7 |
| Tea with Milk | 8.9 | 9.9 | 9.9 |
| Persistent | | | |
| Alkaline-sensitive | 10 | 10 | 9.7 |
| Milk skin | | | |
| Protein containing | | | |
| Egg Yolk | 9.9 | 10 | 10 |
| Starch containing | | | |
| Starch Mix | 10 | 10 | 10 |

10 = best, 1 = worst, a difference of at least 1 is considered distinctive

Notably, the cleaning performance on bleachable stains (tea, tea with milk) is at least comparable to the Comparative Formulation.

The present invention thus addresses the problem of offering a non-aqueous gel comprising a specific bleaching agent, wherein the gel can be used for monodose detergent products as well as for autodosing automatic dishwashing processes.

It will be understood that the embodiments described herein are merely exemplary and that a person skilled in the art may make many variations and modifications without departing from the spirit and scope of the invention. All such variations and modifications, including those discussed above, are intended to be included within the scope of the invention as defined by the appended claims.

1. A non-aqueous gel comprising at least one bleaching agent, characterized in that said at least one bleaching agent comprises coated granules of sodium percarbonate; wherein said non-aqueous gel comprises at least one builder compound; and wherein the non-aqueous gel is substantially free of water.

2. The non-aqueous gel according to claim 1, characterized in that said non-aqueous gel is substantially free of enzymes; and substantially free of bleach activators.

3. The non-aqueous gel according to claim 1, characterized in that said non-aqueous gel comprises 5 to 40 wt of the at least one builder compound.

4. The non-aqueous gel according to claim 1, characterized in that said non-aqueous gel comprises at least two different non-ionic surfactants; wherein the total amount of all non-ionic surfactants ranges from 6 to 60 wt %,

5. The non-aqueous gel according to claim 1, characterized in that the total amount of said coated granules of sodium percarbonate ranges from 5 to 40 wt %.

6. The non-aqueous gel according to claim 1, characterized in that said coated granules of sodium percarbonate have an active oxygen content ranging from 5 to 25 wt %.

7. The non-aqueous gel according to claim 1, characterized in that at least 90% of said coated granules of sodium percarbonate have a particle size ranging from 150 to 1600 micrometers.

8. The non-aqueous gel according to claim 1, characterized in that at least 86% of said coated granules of sodium percarbonate have a particle size ranging from 150 to 1400 micrometers.

9. The non-aqueous gel according to claim 1, characterized in that the sodium percarbonate content of the coated granules of sodium percarbonate ranges from 80 to 95 wt %.

10. A dishwashing water-soluble container characterized in that said water-soluble container is made of a thermoformed water-soluble film comprising poly (vinyl alcohol); wherein said water-soluble container comprises at least a first compartment and at least a second compartment; wherein said at least first compartment is separated from said at least second compartment; wherein said at least first compartment is at least partially filled with a non-aqueous gel according to claim 1; and wherein said at least second compartment is at least partially filled with a dishwashing powder, wherein said dishwashing powder comprises at least one bleaching agent and at least one builder compound.

11. The dishwashing water-soluble container according to claim 10 characterized in that the total amount of the least one builder compound in all compartments, which are at least partially filled with the non-aqueous gel, ranges from 2.5 to 35 wt %, based on the total amount of the non-aqueous gel and the dishwashing powder of all compartments;
and wherein the total amount of the least one builder compound in all compartments, which are at least partially filled with a dishwashing powder, ranges from 2.5 to 35 wt % based on the total amount of the non-aqueous gel and the dishwashing powder of all compartments.

12. The dishwashing water-soluble container according to claim 10 characterized in that the total amount of the coated granules of sodium percarbonate in all compartments, which are at least partially filled with the non-aqueous gel, ranges from 0.1 to 20 wt % based on the total amount of the non-aqueous gel and the dishwashing powder of all compartments.

13. An autodosing automatic dishwashing system characterized in that said autodosing automatic dishwashing system comprises at least a first cartridge and at least a second cartridge arranged separated from each other inside of a dishwashing apparatus, wherein said at least first cartridge is at least partially filled with a non-aqueous gel according to claim 1; and wherein said second cartridge is at least partially filled with a dishwashing powder, which is comprising at least one bleaching agent and at least one builder compound;
or alternatively characterized in that said autodosing automatic dishwashing system comprises a cartridge comprising at least a first cartridge compartment and at least a second cartridge compartment separated from each other inside of said cartridge, wherein said first cartridge compartment is at least partially filled with a non-aqueous gel according to claim 1; and wherein said second cartridge compartment is at least partially filled with a dishwashing powder, which is comprising at least one bleaching agent and at least one builder compound.

14. The autodosing automatic dishwashing system according to claim 13 characterized in that the total amount of the least one builder compound in all cartridges or cartridge compartments, which are at least partially filled with the non-aqueous gel, ranges from 2.5 to 35 wt % based on the total amount of the non-aqueous gel and the dishwashing powder of all cartridges or cartridge compartments;
and wherein the total amount of the least one builder compound in all cartridges or cartridge compartments, which are at least partially filled with a dishwashing powder, ranges from 2.5 to 35 wt % based on the total amount of the non-aqueous gel and the dishwashing powder of all cartridges or cartridge compartments.

15. The autodosing automatic dishwashing system according to claim 13 characterized in that the total amount of the coated granules of sodium percarbonate in all cartridges or cartridge compartments, which are at least partially filled with the non-aqueous gel, ranges from 0.1 to 20 wt % based on the total amount of the non-aqueous gel and the dishwashing powder of all cartridges or cartridge compartments;
